(19) United States
(12) Patent Application Publication
(10) Pub. No.: US 2018/0004552 A1
(43) Pub. Date: Jan. 4, 2018

(54) Systems and Methods for Emulating Resources Using Abstract Containerization with Abstract Categorization and Policy Setting

(71) Applicant: Sphere 3D Inc., Mississauga (CA)

(72) Inventors: Giovanni Morelli, Mississauga (CA); Peter G. Bookman, Huntsville, UT (US); Brandon Cowen, Mississauga (CA)

(73) Assignee: Sphere 3D Inc.

(21) Appl. No.: 15/637,085

(22) Filed: Jun. 29, 2017

Related U.S. Application Data
(60) Provisional application No. 62/356,157, filed on Jun. 29, 2016.

(51) Int. Cl. G06F 9/455; H04L 29/08

(52) U.S. Cl. CPC G06F 9/45508; H04L 67/08

(57) ABSTRACT

Various embodiments are described herein for methods and systems for providing, at a user device, an online emulation via a host server. A plurality of resources are provided via a host server by providing a plurality of initial software applications. Each resource in the plurality of resources is included in at least one initial software application in the plurality of initial software applications. A customized software application for emulation at the user device is defined to include a set of functionalities with at least one distinguishing functionality that is absent from each initial software application. The host server determines a set of resources for providing the set of functionalities and provides the emulation by accessing and running the set of resources.

### RELATED APPLICATIONS

This application claims the benefit of U.S. Provisional Application No. 62/356,157, filed Jun. 29, 2016 entitled “SYSTEMS AND METHODS FOR EMULATING RESOURCES USING ABSTRACT CONTAINERIZATION WITH ABSTRACT CATEGORIZATION AND POLICY SETTING”, the entirety of which is incorporated herein by reference.

### FIELD

This disclosure relates generally to systems and methods for providing online emulations and in particular, to systems and methods for providing online emulations of customized software applications.

### BACKGROUND

The following is not an admission that anything discussed below is part of the prior art or part of the common general knowledge of a person skilled in the art.

Emulations can be used to provide a range of computational functionality to a user by operating a range of hardware and software resources that are remote from a user device. A user may install or otherwise access an emulation application that interfaces with a host server that provides the resource emulation. The user can then operate the emulated resources required for a software application without needing to have the necessary hardware or the software application installed on their device.

Emulations generally rely on a combination of several resources to provide defined functionality. Resources can include hardware resources, such as graphics processing units, and software resources, such as software applications. When a user requests an emulation of a software application, the emulation system may provide the hardware and software resources necessary to provide that software application. To facilitate the emulation of a software application, the emulation system may containerize the resources associated with that software application. The emulation system may specify each of the resources required (software and hardware) for a particular application within a container such that the emulation system can more readily provide that particular emulation when requested.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

Various embodiments are described herein that generally relate to methods and systems for emulating resources using abstract containerization with abstract resource categorization and policy setting. Embodiments described herein may provide emulations of customized software applications to user devices via a host server.

In a broad aspect, at least one embodiment herein provides a method of providing, at a user device, an online emulation via a host server. The method can include providing a plurality of resources via the host server, by providing a plurality of software applications. Each initial software application in the plurality of software applications may include at least one associated resource in the plurality of resources, and each resource in the plurality of resources may be included in at least one initial software application in the plurality of initial software applications. The method can also include defining a customized software application for emulation at the user device via the host server. Emulation of the customized software application may involve a set of functionalities, and, relative to each initial software application in the plurality of initial software applications, the set of functionalities may include a distinguishing functionality of the customized software application absent from that initial software application. The method can also include operating the host server to determine a set of resources in the plurality of resources for providing the customized software application, by, for each functionality in the set of functionalities, determining a corresponding resource in the plurality of resources for providing that functionality. The method may also include providing the online emulation via the host server of the customized software application by accessing and running the set of resources.

In some embodiments, the described methods may further include defining a plurality of abstract resource categories accessible via the host server. Each abstract resource category in the plurality of abstract resource categories may include at least one associated resource in the plurality of resources for providing at least one functionality in the set of functionalities. The method can also include partitioning the plurality of resources between the plurality of abstract resource categories such that each resource in the plurality of resources is partitioned into a corresponding abstract resource category in the plurality of abstract resource categories, and at least one abstract resource category in the plurality of abstract resource categories includes at least two resources in the plurality of resources. The method can also providing at least a first phase of the online emulation via the host server of the customized software application followed by providing a second phase of the online emulation via the host server of the customized software application. During the first phase of the online emulation, the host server may provide the online emulation using a first resource of the at least two resources in the plurality of resources and during the second phase of the online emulation, the host server may provide the online emulation using a second resource of the at least two resources in the plurality of resources.

In some embodiments, during the first phase of the online emulation, the host server may provide the online emulation using the first resource of the at least two resources in the plurality of resources to provide a first functionality in the set of functionalities, and during the second phase of the online emulation, the host server may provide the online emulation using a second resource of the at least two resources in the plurality of resources to provide a second functionality in the set of functionalities, the first functionality being different from the second functionality.

In some embodiments the described methods may further include receiving and recognizing at the host server a phase-transition signal originating at the user device based on an action by the user. The method can also include determining from the phase-transition signal, the second functionality in the at least two functionalities in the set of functionalities required based on the user action, and the second resource in the at least two resources in the plurality of resources required to provide that second functionality; and responsive to determining from the phase-transition signal, the second functionality and the second resource, transitioning the online emulation from the first phase to the second phase.

In some embodiments, the described methods may further include receiving and recognizing at the host server a phase-transition signal originating at the user device based on a change in location of the user device. The method can also include determining from the phase-transition signal, the second resource of the at least two resources required based on the change in location of the user device; and, responsive to determining from the phase-transition signal the second resource, transitioning the online emulation from the first phase to the second phase.

In some embodiments, the described methods may further include providing an additional online emulation at another user device via the host server. The method can also include during the additional online emulation, determining that the first resource of the at least two resources in the plurality of resources is to be used to provide the additional online emulation. The method can also include switching the online emulation from the first phase using the first resource of the at least two resources to the second phase not using the first resource of the at least two resources, and then, during the second phase, using the first resource of the at least two resources to provide the additional online emulation to the another user device.

In some embodiments, the described methods may further include determining a problem in relation to the first resource of the at least two resources. The method can also include in response to determining the problem in relation to the first resource of the at least two resources, switching the online emulation from the first phase using the first resource of the at least two resources to the second phase not using the first resource of the at least two resources.

In some embodiments, the described methods can further include determining a plurality of user-side resources usable to provide the emulation at the user device, the user-side resources being available on the user device. The method can also include partitioning the plurality of user-side resources between the plurality of abstract resource categories such that each user-side resource in the plurality of user-side resources is partitioned into a corresponding abstract resource category in the plurality of abstract resource categories, and at least one other abstract resource category in the plurality of abstract resource categories includes at least one resource in the plurality of resources and at least one user-side resource in the plurality of user-side resources. The method can also include providing the online emulation via the host server of the customized software application by providing an initial phase of the online emulation via the host server of the customized software application followed by providing a subsequent phase of the online emulation via the host server of the customized software application. During the initial phase of the online emulation, the host server may provide the online emulation using an initial resource in the at least one other abstract resource category. During the subsequent phase of the online emulation, the host server may provide the online emulation using a subsequent resource in the other abstract resource category. The plurality of resources may include one of the initial resource and the subsequent resource, and the plurality of user-side resources may include the other of the initial resource in a subsequent resource.

In some embodiments, the described methods can further include providing, at a plurality of user devices, a plurality of online emulations via the host server; and for each user device in the plurality of user devices, defining a corresponding customized software application for emulation at that user device. In some embodiments, for at least a first user device in the plurality of user devices, and a second user device in the plurality of user devices, the customized software application for emulation at the first user device may differ from the customized software application for emulation at the second user device.

In some embodiments, the described methods can further include, for at least some user devices in the plurality of user devices, denying access to resources within at least one abstract resource category in the plurality of abstract resource categories based, at least in part, on the corresponding customized software application being emulated at that user device.

In some embodiments, the described methods can further include providing a plurality of user records defining a plurality of users. For each user device in the plurality of user devices, the plurality of user records may include a user record identifying a corresponding user for that user device. Each user record in the plurality of user records may include corresponding user access information. The method can also include for at least some user devices in the plurality of user devices, denying access to resources within at least one abstract resource category in the plurality of abstract resource categories based, at least in part, on the corresponding user access information stored in the user record for that user device.

In some embodiments, the described methods can further include providing a plurality of user records defining a plurality of users. For each user device in the plurality of user devices, the plurality of user records may include a user record identifying a corresponding user for that user device. Each user record in the plurality of user records may include corresponding user access information. The method can also include for at least some user devices in the plurality of user devices, denying access to resources within at least one abstract resource category in the plurality of abstract resource categories based, at least in part, on the corresponding user access information stored in the user record for that user device and the corresponding customized software application being emulated at that user device.

In another board aspect, at least one embodiment herein provides a system for providing an online emulation at a user device. The system may include a host server in communication with the user device; the host server can include a host processor and a host memory. The host memory may configured to store a plurality of initial software applications accessible via the host server, each initial software application in the plurality of software applications including at least one associated resource in a plurality of resources, and each resource in the plurality of resources is included in at least one initial software application in the plurality of initial software applications; and the host processor may be configured to: define a customized software application for emulation at the user device, where emulation of the customized software application involves a set of functionalities, and, relative to each initial software application in the plurality of initial software applications stored in the host memory, the set of functionalities can include a distinguishing functionality of the customized software application absent from that initial software application; determine a set of resources in the plurality of resources for providing the customized software application by, for each functionality in the set of functionalities, determining a corresponding resource in the plurality of resources for providing that functionality; and provide the online emulation of the customized software application by accessing and running the set of resources.

In some embodiments, the host processor may be further configured to: define a plurality of abstract resource categories accessible via the host server, where each abstract resource category in the plurality of abstract resource categories includes at least one associated resource in the plurality of resources for providing at least one functionality in the set of functionalities; store the plurality of abstract resource categories in the host memory; partition the plurality of resources between the plurality of abstract resource categories such that each resource in the plurality of resources is partitioned into a corresponding abstract resource category in the plurality of abstract resource categories, and at least one abstract resource category in the plurality of abstract resource categories comprises at least two resources in the plurality of resources; and, provide the online emulation of the customized software application by providing at least a first phase of the online emulation of the customized software application followed by providing a second phase of the online emulation of the customized software application, where during the first phase of the online emulation, the online emulation is provided using a first resource of the at least two resources in the plurality of resources and during the second phase of the online emulation the online emulation is provided using a second resource of the at least two resources in the plurality of resources.

In some embodiments, the host processor may be further configured to provide the online emulation using the first resource of the at least two resources in the plurality of resources to provide a first functionality in the set of functionalities during the first phase of the online emulation; and provide the online emulation using a second resource of the at least two resources in the plurality of resources to provide a second functionality in the set of functionalities during the second phase of the online emulation, where the first functionality being different from the second functionality.

In some embodiments, the host processor may be further configured to receive and recognize a phase-transition signal originating at the user device based on an action by the user; determine from the phase-transition signal, the second functionality in the at least two functionalities in the set of functionalities required based on the user action, and the second resource in the at least two resources in the plurality of resources required to provide that second functionality; and, transition the online emulation from the first phase to the second phase in response to determining the second functionality and the second resource from the phase-transition signal.

In some embodiments, the host processor may be further configured to: receive and recognize a phase-transition signal originating at the user device based on a change in location of the user device; determine from the phase-transition signal, the second resource of the at least two resources required based on the change in location of the user device; and, transition the online emulation from the first phase to the second phase in response to determining the second resource from the phase-transition signal.

In some embodiments, the host processor may be further configured to: provide an additional online emulation at another user device; determine that the first resource of the at least two resources in the plurality of resources is to be used to provide the additional online emulation; switch the online emulation from the first phase using the first resource of the at least two resources to the second phase not using the first resource of the at least two resources; and subsequently, during the second phase, use the first resource of the at least two resources to provide the additional online emulation to the another user device.

In some embodiments, the host processor may be further configured to: determine a problem in relation to the first resource of the at least two resources; and switch the online emulation from the first phase using the first resource of the at least two resources to the second phase not using the first resource of the at least two resources in response to determining the problem in relation to the first resource of the at least two resources.

In some embodiments, the host processor may be further configured to: determine a plurality of user-side resources usable to provide the emulation at the user device, the user-side resources being available on the user device; partition the plurality of user-side resources between the plurality of abstract resource categories stored in the host memory such that each user-side resource in the plurality of user-side resources is partitioned into a corresponding abstract resource category in the plurality of abstract resource categories, and at least one other abstract resource category in the plurality of abstract resource categories comprises at least one resource in the plurality of resources and at least one user-side resource in the plurality of user-side resources; provide the online emulation of the customized software application by providing an initial phase of the online emulation via the host server of the customized software application followed by providing a subsequent phase of the online emulation via the host server of the customized software application, and during the initial phase of the online emulation, the online emulation may be provided using an initial resource in the at least one other abstract resource category; during the subsequent phase of the online emulation, the online emulation may be provided using a subsequent resource in the other abstract resource category; and the plurality of resources may include one of the initial resource and the subsequent resource, and the plurality of user-side resources may include the other of the initial resource in a subsequent resource.

In some embodiments, the host processor may be further configured to: provide the online emulation at the user device by providing a plurality of online emulations at a plurality of user devices; and define the customized software application for emulation at the user device by, for each user device in the plurality of user devices, defining a corresponding customized software application for emulation at that user device.

In some embodiments, for at least a first user device in the plurality of user devices, and a second user device in the plurality of user devices, the customized software application for emulation at the first user device differs from the customized software application for emulation at the second user device.

In some embodiments, the host processor may be further configured to: for at least some user devices in the plurality of user devices, deny access to resources within at least one abstract resource category in the plurality of abstract resource categories based, at least in part, on the corresponding customized software application being emulated at that user device.

In some embodiments, the host memory may be configured to store a plurality of user records defining a plurality of users, where i) for each user device in the plurality of user devices, the plurality of user records comprises a user record identifying a corresponding user for that user device; and, ii) each user record in the plurality of user records comprises a corresponding user access information; and, the host processor may be configured to, for at least some user devices in the plurality of user devices, deny access to resources within at least one abstract resource category in the plurality of abstract resource categories based, at least in part, on the corresponding user access information stored in the user record for that user device.

In some embodiments, the host memory may be configured to store a plurality of user records defining a plurality of users, where i) for each user device in the plurality of user devices, the plurality of user records comprises a user record identifying a corresponding user for that user device; and, ii) each user record in the plurality of user records comprises a corresponding user access information; and, the host processor may be configured to, for at least some user devices in the plurality of user devices, deny access to resources within at least one abstract resource category in the plurality of abstract resource categories based, at least in part, on the corresponding user access information stored in the user record for that user device and the corresponding customized software application being emulated at that user device.

In accordance with another broad aspect, there is provided a computer program product comprising a non-transitory computer-readable storage medium having stored thereon computer-executable instructions for configuring a processor of a host server to perform a method of providing, at a user device, an online emulation, wherein the method is described herein.

These and other aspects and features of various embodiments will be described in greater detail below.

### BRIEF DESCRIPTION OF DRAWINGS

For a better understanding of the described embodiments and to show more clearly how they may be carried into effect, reference will now be made, by way of example, to the accompanying drawings in which:

FIG. 1 is a block diagram illustrating a system for providing an online emulation in accordance with an example embodiment;

FIG. 2 is a flowchart of a process of providing an online emulation in accordance with an example embodiment; and

FIG. 3 is a flowchart of another process of providing an online emulation in accordance with an example embodiment.

FIG. 4 is a flowchart of an example process of transition between emulation phases in an online emulation in accordance with an example embodiment.

The drawings, described below, are provided for purposes of illustration, and not of limitation, of the aspects and features of various examples of embodiments described herein. The drawings are not intended to limit the scope of the teachings in any way. It will be appreciated that for simplicity and clarity of illustration, where considered appropriate, reference numerals may be repeated among the figures to indicate corresponding or analogous elements or steps.

### DESCRIPTION OF EXAMPLE EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

The various embodiments described herein generally relate to systems and methods for emulating resources for user devices via a host server. A user may interact with a user device to access a customized software application provided by the host server. The host server may emulate a customized software application using a set of resources, which may include resources associated with an initial software application. In embodiments described herein, a host server may implement methods for abstract containerization of resources to provide the customized software applications. Software resources associated with initial software applications available through the host server can be allocated to abstract resource categories based on the functionalities they provide. The abstract resource categories may then be used to identify resources required to provide a user with a customized software application that includes a set of resources that is not available in any single initial software application on the host server. In general, the set of resources associated with a software application refers to the software resources for that software application. In some instances, hardware resources may also be required to implement a software application, i.e. because they are necessary to support the software resources associated with the software application. In some instances, these hardware resources may also be stored at the user device or at the host server.

The customized software application may provide functionality (and the corresponding resources) absent in an initial software application. This may permit a user to continue to use an initial software application with some additional functionality beyond that typically provided by the initial software application. For instance, a user may be enabled to continue using a legacy version of a particular software application with added functionality that is absent from the initial legacy version of that software. In some cases, the host server may implement policies that limit the resources available to particular users, e.g. based on user records that define user access information such as subscription levels.

Consider online sharing of documents or files. Users may receive documents or files from other users through such document sharing applications or email. For example, documents or files may be shared online through a cloud database to be viewed and edited online or to be downloaded by a user. In order to access the files a user typically requires the corresponding type of software application to run the file and/or document. For instance, a user may receive a word processing file (e.g. a .doc file), a presentation file (e.g. a .ppt file), or a spreadsheet file (e.g. an .xls file). In order to access the files, the user may then need to operate the corresponding software application, in the above cases a word processing application (e.g. Word®), a presentation application (e.g. Microsoft PowerPoint®), or a spreadsheet application (e.g. Excel®) respectively.

In some cases, the version of a software application that is used by a first user to generate a file may be different from the version of the software application used by a second user with whom a file is shared. For example, the first user may generate a file using Microsoft Word 2016 while the second user is operating Microsoft Word 2010. The second user may require additional functionality that is absent or missing from Microsoft Word 2010 in order to fully access or manipulate the received a file. Accordingly, in embodiments described herein an emulation of a customized software application may be provided for the user. The customized software application emulation may include resources associated with Microsoft Word 2010 as well as additional resources corresponding to the additional functionality required for the received file are also provided. Thus, the user is able to continue to use the version of the software application to which they are accustomed, with additional functionality provided by the corresponding additional resources.

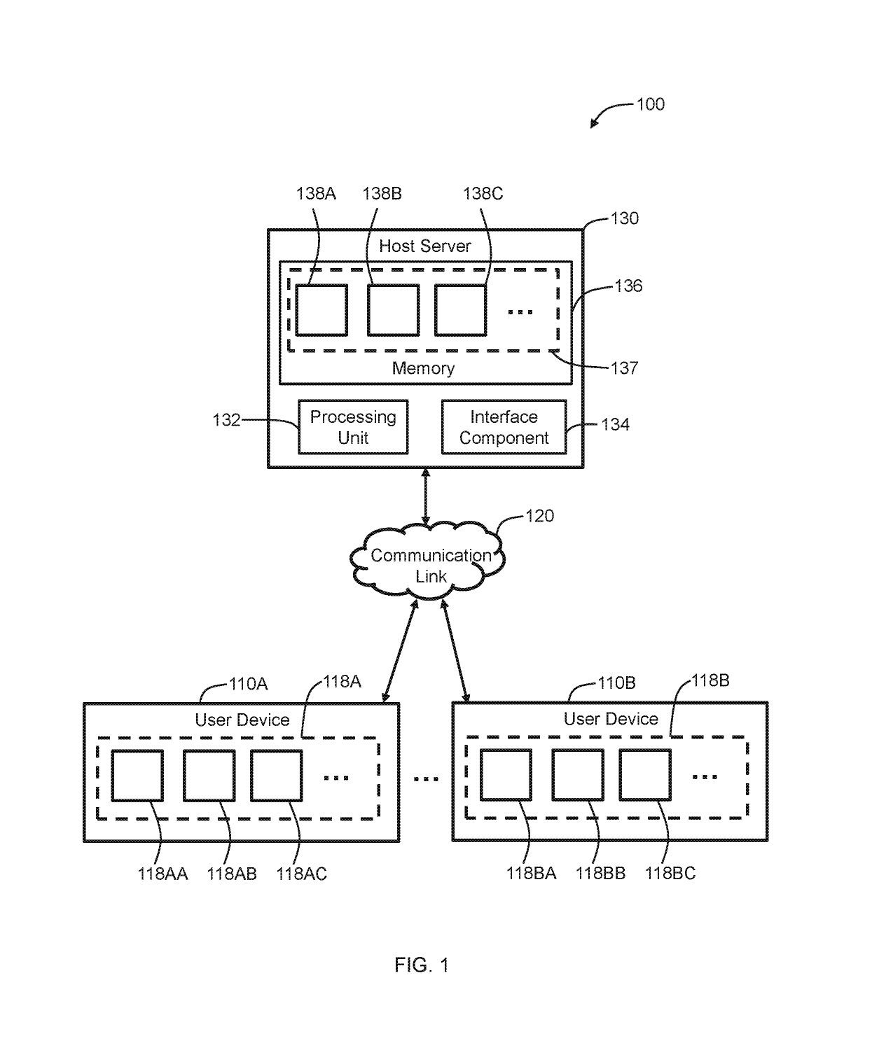

Reference is first made to FIG. 1, which shows a block diagram of an example system 100 for providing an online emulation at a user device.

In the example illustrated, system 100 includes a plurality of user devices 110 in communication with a host server 130 via a communication link 120. The user devices 110 may be located remotely from the host server 130. System 100 is an example of a system that may be used to emulate a customized software application for a user device 110 via host server 130.

System 100 may also be referred to as a resource emulation system. System 100 also includes a plurality of resources 138. The resources 138 may be stored in a resource library 137. Each resource 138 may have an associated functionality that it provides. The functionality associated with a resource 138 generally refers to the operations or range of operations that resource is capable of providing.

The plurality of resources 138 of the host server 130, such as resources 138A, 138B, and 138C, and the plurality of user-side resources 118, such as 118A, 118B, and 118C, may include a plurality of different software resource kinds and a plurality of different software resource types.

Software resources may include software applications such as Microsoft Word™, PowerPoint™, Excel™, speech recognition software, or game applications for example. Software resources may also include user-developed applications or customized software applications. Software resources may also include components of existing software applications. Software resources may include files written in a computer programming language such as C/C++ or Java. These files may include one or more subroutines (for example, a file may contain a subroutine for viewing Microsoft® Word files and another subroutine for editing Microsoft® Word files). Software resources may further include, for example, dynamic-link library (DLL) file(s) for providing existing Microsoft® Word/PowerPoint®/Excel® features, hardware driver file(s) for initiating and maintaining Internet connection and data transfer, and/or hardware driver file(s) for controlling peripheral devices. Some of these files may also include one or more subroutines (for example, a developer may be able to access individual subroutines within a Microsoft® DLL). Further, resources may include combinations of resources. Additional resources may be added to either a host server 130 or a user device 110. For example, a software application may be uploaded to the host server 130 by a user of a user device 110.

In some cases, the host server 130 may also include, or be able to access, hardware resources (not shown). For example, hardware resources may include central processing units (CPU), graphics processing units (GPU), and memory storage units, such as hard drives or flash memory devices, or random access memory (RAM). Hardware resources may also include software emulations of hardware resources.

In the example shown in FIG. 1, the resources 138 are located on the host server 130. Alternatively, the resources 138 may be located remotely from the host server 130 although still accessible to the host server 130. The resources 138 may be located in distributed locations, each of which is accessible to host server 130. For instance, the resources 138 may be distributed geographically to enable user devices 110 to access nearby resources 138 based on a device location. The host server 130 may coordinate the allocation of the resources 138 and user devices 110.

Although two user devices 110A and 110B are illustrated in FIG. 1, a skilled reader will appreciate that a lesser or greater number of user devices 110 may communicate with the host server 130 via the communication link 120.

Similarly, although only one host server 130 is shown in FIG. 1, it will be understood that host server 130 can include a plurality of servers that may be distributed over a wide geographic area in electronic communication with each other, and with the other components shown in FIG. 1, via the communication link 120.

The user devices 110 may be any networked computing device operable to connect with the communication link 120 through a wired or wireless connection. In general, the user devices 110 may include at least a processor and memory (not shown). The user devices 110 may be any remote processing device such as an electronic tablet device, a personal computer, workstation, server, portable computer, mobile device, personal digital assistant, laptop, smart phone, WAP phone, an interactive television, video display terminals, gaming consoles, portable electronic devices and the like. In some embodiments, the user devices 110 may be a laptop or a smart phone device equipped with a network adapter for connecting to the Internet through the communication link 120.

The communication link 120 may be any network capable of carrying data, such as the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these, capable of interfacing with, and enabling communication between host server 130 and user devices 110.

The user devices 110 may also include a plurality of user-side resources 118. For example, device 110A has user-side resources 118AA, 118BB, and 118CC. The plurality of user-side resources 118 may be stored at the user device, for example, in a user device storage device (not shown). The user-side resources 118 may generally refer to resources available locally on the user device 110, such as software applications or libraries installed locally on the user device 110. The user device 110 may also include the device hardware resources.

As shown in FIG. 1, the host server 130 may include one or more components, such as a host processing unit 132, a host interface component 134, and memory 136. While resources 138 such as resources 138A, 138B, and 138C are shown stored in the memory 136 of host server 130, in some embodiments the resources 138 may be separate from the host server 130. Similarly, the resources 138 may be provided by a plurality of servers that can be distributed over a wide geographic area and are in electronic communication with the host server 130. It will be understood that although only three resources 138A, 138B, and 138C are illustrated in FIG. 1, a lesser or greater number of user resources may be possible.

Generally, the host processing unit 132 can be configured to control the operation of the host server 130. For example, the host processing unit 132 may initiate and manage the operations of each of the other components at the host server 130. The host processing unit 132 may also control and manage access to the resources 138 and manage the emulations provided by server 130.

The host processing unit 132 may be any suitable processor(s), controller(s) and/or digital signal processor(s) that may provide sufficient processing power depending on the configuration, purpose and requirements of the host server 130. In some embodiments, the host processing unit 132 may include more than one processor with each processor being configured to perform different dedicated tasks.

The host interface component 134 may be any interface that enables the host server 130 to communicate with other devices and systems. In some embodiments, the host interface component 134 may include at least one of a serial port, a parallel port or a USB port. The host interface component 134 may also include at least one of an Internet, Local Area Network (LAN), Ethernet, Firewire™, modem or digital subscriber line connection. The host interface component 134 can include both wired and wireless connections. Various combinations of these elements may be incorporated within the host interface component 134.

The memory 136 may include suitable data storage elements, such as one or more databases. The memory 136 may include volatile and non-volatile elements. Non-volatile memory stores computer programs consisting of computer-executable instructions, which may be loaded into volatile memory for execution by processor 132 as needed. It will be understood by those of skill in the art that references herein to the host server 130 as carrying out a function or acting in a particular way imply that processor 132 is executing instructions (e.g., a software program) stored in memory 136 and possibly transmitting or receiving inputs and outputs via one or more interface. Memory 136 may also store data input to, or output from, processor 132 in the course of executing the computer-executable instructions.

The memory 136 may include a resource database indicating the resources 138 available via host server 130 and the locations of resources 138. The memory 136 may also store a plurality of initial software applications accessible via the host server 130. Each initial software application may have an associated application class (also referred to as an application category), such as a word processing application, a presentation application, a spreadsheet application etc. Other examples of application classes may include applications for viewing, editing and saving other types of files such as PDF files; applications or subroutines for managing Internet connection; applications or subroutines for file management (in particular, especially when Internet connection is interrupted); applications or subroutines for controlling peripheral devices such as microphone, speaker, touchscreen, and so forth.

Similarly, each initial software application may also have an associated application type or brand, such as Word® or WordPerfect® word processing applications, PowerPoint® or Keynote® presentation applications, and Excel® or Numbers® spreadsheet applications. Each initial software application may also have an associated application version, such as Word® 2010, Word® 2013, or Word® 2016. An initial software application generally refers to a defined combination of a specific class, type/brand and version of a software application.

Each initial software application may have at least one associated resource in the plurality of resources 138. As well, each of the resources 138 may be included in at least one of the initial software applications. As used herein, the associated resources for a software application refer to the software resources used to provide that software application. That is, resources 138 that are included in an initial software application are software resources. In general, the resources 138 associated with a first initial software application may different from the resources 138 associated with a second initial software application.

In embodiments described herein, the processor 132 may be configured to define a customized software application for emulation at the user device 110. The customized software application may be defined by a user of the user device 110, for instance interacting with the host server 130 through a web portal or emulation application. Alternatively, the customized software application may be defined by an administrator of the host server 130. The customized software application may then be stored in the host memory 136. The customized software application may then be available for emulation on user devices 110 via the host server 130.

A customized software application may also be referred to as a purely notional software application, as prior to the emulation, the customized software application did not exist. In some cases, the customized software application may include a combination of features/functionalities from different versions of existing software. For example, the customized software application could include an early version of a word processing program incorporating some functionality from later versions of the word processing program.

The customized software application may be defined to have an associated set of functionalities that are available during emulation of that customized software application. As compared to each of the initial software application stored on the host server 130, the set of functionalities for each customized software application can include at least one distinguishing functionality that is absent from the initial software application.

In some embodiments, each customized software application may correspond to a particular class of software application. However, the customized software application may include functionalities from multiple types and/or versions of applications within that class. This may permit a user to optimize the functions they are able to use within that class of software application.

In some embodiments, some or all of the customized software applications may correspond to a particular class and type/brand of software application. In such cases, the customized software applications may include functionalities from multiple versions of the application class and type/brand. This may permit a user to continue to use a legacy version of a particular application with which they are familiar, while still accessing additional functionality they may need. For instance, a user operating a legacy version of a word processing application may create a customized software application that also includes an equation editing functionality from a later version of that word processing application.

In some cases, the customized software applications may include functionalities from multiple classes of initial software applications. For instance, a customized document sharing/editing application may include functionalities from word processing applications, presentation applications and spreadsheet applications.

When a user requests an emulation of a customized software application, the host server 130 may determine a set of resources for providing the customized software application by determining the resources 138 corresponding to each functionality in the set of functionalities for that customized software application. The host server 130 may then provide the emulation by accessing and running that set of resources.

In some embodiments, the host server 130 may define a plurality of abstract resource categories accessible via the host server 130. The resources 138 may be partitioned between the abstract resource categories by allocating each resource 138 to one of the abstract resource categories.

In some cases, one or more abstract resource categories may be defined based on a software application class. For example, the host server 130 may determine the functionalities associated with each of the software applications within a particular software application class and define that as the set of functionalities for the software application class. The host server 130 may then partition the resources 138 to the abstract resource category for that software application class by identifying at least one resource that corresponds to each functionality in the set of functionalities for the software application class. Accordingly, when a user requests an emulation of a customized software application within that software application class, the host server 130 may access the resources 138 in the associated abstract resource category. When a user requests an emulation of a customized software application that includes functionalities from a plurality of software application classes, the host server 130 may access resources 138 in the associated abstract resource category for each of the software application classes whose functionalities are included in the customized software application.

In some cases, the abstract resource categories (and corresponding partitioning of the resources 138) may be performed based on a category set of functionalities. Each abstract resource category may be defined based on a particular functionality or category set of functionalities associated with that resource category. For example, interrelated functions may be defined within a single abstract resource category. Each resource 138 may be partitioned into a corresponding abstract resource category in the plurality of abstract resource categories with an associated category set of functionalities that corresponds to the functionality of that resource 138.

In some cases, however, the user may not be permitted to access all of the resources in the associated abstract resource category. That is, the host server 130 may deny access to certain resources within an abstract resource category based, at least in part, on the corresponding customized software application being emulated at a user device 110. For example, if the set of functionalities for the customized software application being emulated at the user device 110 does not include some of the functionality available in the abstract resource class, the user device 110 may be denied access to the associated resources.

In some cases, the host server 130 may store a plurality of user records defining a plurality of users. The plurality of user records may include a user record identifying a corresponding user for each user device 110. In some cases, each user record may include corresponding user access information. For example, the user access information may be a permission level or a subscription associated with the user. The host server may then deny access to resources within at least one abstract resource category based, at least in part, on the corresponding user access information stored in the user record for that user device. In some cases, the host server 130 may deny access to resources within at least one abstract resource category based, at least in part, on the corresponding user access information stored in the user record for that user device and the corresponding customized software application being emulated at that user device.

In some instances, the host server 130 may store the user-side resources 118 associated with a user device 110 in the user records for the corresponding user. The user-side resources 118 may also be partitioned into the abstract resource categories stored in the host memory 138.

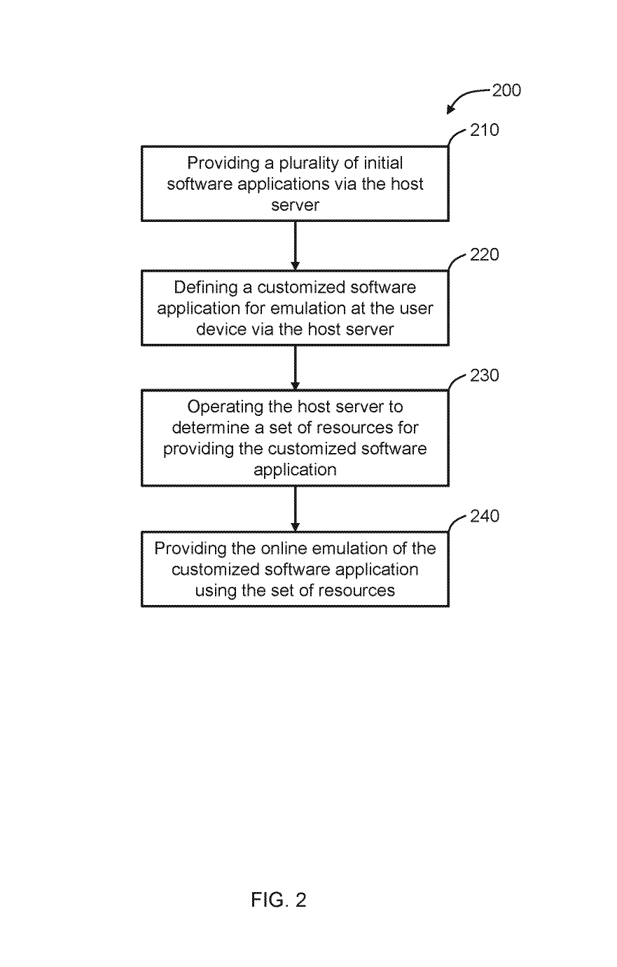

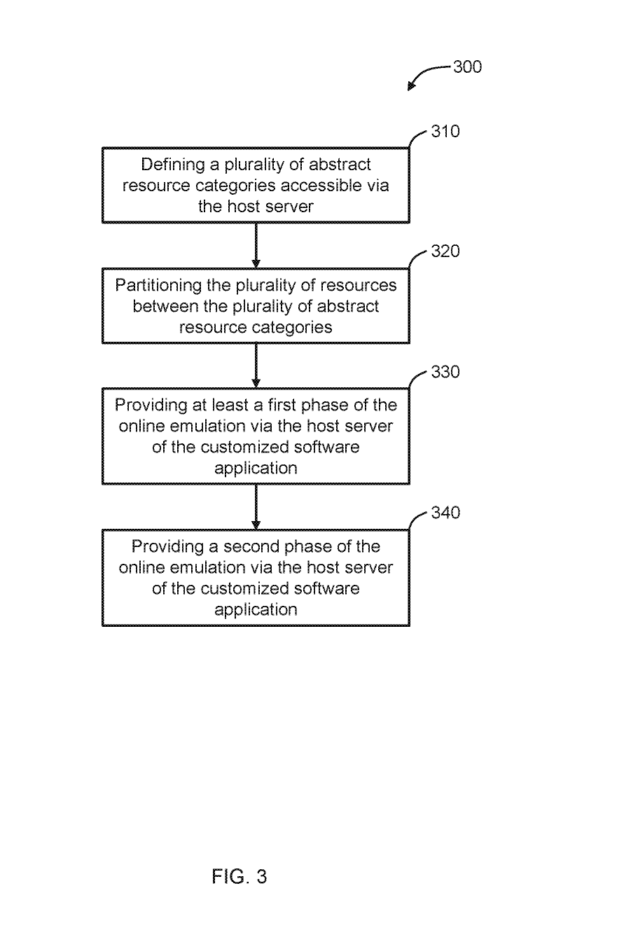

The host processing unit 132 may use the resources 138 of the host server 130 and/or user-side resources 118 to emulate a customized software application at user device 110. Examples of emulation of customized software applications using the resources will be described in greater detail with reference to FIGS. 2 to 3.

Referring now to FIG. 2, shown therein is a flowchart of an example embodiment of a method 200 of providing an online emulation at a user device 110. Method 200 is an example of a method that may be used to emulate a customized software application at a user device 110 via a host server 130.

At 210, a plurality of resources 138 may be provided via the host server 130. For instance, the plurality of resources 138 may be stored as a resource library 137. The resource library 137 may identify the resources 138 available via the host server 130.

The host server 130 may provide a plurality of initial software applications. These initial software applications may correspond to software applications available to be emulated through the host server 130. The initial software applications may correspond to virtual instances of applications that might otherwise be installed and operated locally on a user device 110.

Each initial software application may have at least one associated resource in the plurality of associated resources. Each resource 138 may be included in at least one of the initial software applications. That is, the resources 138 may be available at host server 130 because the host server 130 has provided resources necessary to support the initial software applications.

At 220, a customized software application can be defined for emulation at the user device 110. The customized software application may be defined, for example, by the processing unit 132. The customized software application may be defined in response to user input through a web portal or uploading of a customized software application by a user device 110. Alternatively, the customized software application may be defined by the host server 130 in response to a request from a user for particular functionalities.

Each custom software application may be defined to have an associated set of functionalities that are involved in emulating the custom software application. The set of functionalities for each custom software application may include one or more distinguishing functionalities relative to each of the initial software applications. These distinguishing functionalities refer to functionalities available in the customized software application that are missing or absent from the initial software application. For example, an initial software application may be an early version of a word processing application and the customized software application may include functionalities from that version (i.e. common functionalities) as well as additional functionalities from later versions of the word processing application, missing in the earlier version (i.e. distinguishing functionalities). In another example, the customized software application may include functionalities from multiples classes of initial software applications that are not available in other classes of initial software applications. Such customized software applications may be referred to as blended software applications in the sense that the set of functionalities available during an emulation of that software application are a blend or combination of the functionalities available from multiple initial software applications. This may provide a software application tailored to a user's particular needs.

For example, a user may wish to use an early version of a word processing application but require the capability of editing chemical equations—a functionality only supported by a subsequent version of the application. The customized software application may then be defined to include primarily the functionalities from the early version of the word processing program and in addition, features from some later version of the word processing program may be determined to correspond to other functionality required by the user not present in the earlier version.

In some cases, the customized software applications may also omit certain functionalities from one or more of the initial software applications. Accordingly, the customized software application may provide a streamlined set of functionalities particularly suited to the user or user device 110.

At 230, the host server 130 may determine a set of resources 138 for providing a customized software application. For instance, the host server 130 may receive a request from a user device 110 for a particular customized application. In response to the request, the host server 130 may determine the resources required to provide the emulation.

The set of resources for providing the customized software application may be determined based on the set of functionalities for the customized software application. For each functionality in the set of functionalities, the host server 130 can determine a corresponding resource 138 for providing that functionality

A corresponding resource can be determined to provide each functionality of the customized software application. The corresponding resources may be determined, for example, by the processing unit 132.

In some cases, the host server 130 may determine the set of resources taking into account user context. The host server 130 may determine the corresponding resources based on a characteristic of the user device, such as the operating system. For example, the corresponding resources may be different for a user device running Mac OS relative to a user device running Microsoft Windows.

In some embodiments, the host server 130 may determine the corresponding resources based on the system capability of the user device. For example, the user device 110 may include user-side resources 118 for controlling peripheral devices such as microphone, speaker, touchscreen, etc.; therefore it may not be necessary for the host server 130 to supply any such resources.

The host server 130 may also determine the corresponding resources based on the geographical location of the user. In some cases, the resources may be selected to reduce latency for the user. For example, when a user in Canada uses his mobile device to access the Internet to emulate a computer program product and the system determines that resources to provide that emulation will need to be, or at least are more advantageously, accessed in the United States, the system can make resource allocation decisions based on this context. Specifically, a first wireless Internet connection through a first Canadian service provider might normally be preferred, but given the US connectivity required or preferred, a second Canadian service provider might be selected because of superior interconnectivity with a first US service provider usable to access the US resources required or preferred to provide the emulation.

At 240, the online emulation can be provided to the user device 110 via the host server 130 by accessing and running the set of resources determined at 230. For example, the host processing unit 132 may access and run resources 138 at the host server 138 and/or resources 118 at the user device 110 through the interface component 134 and communication link 120. A user may then operate the customized software application by interacting with the resources 138 through their device 110.

Referring now to FIG. 3, shown therein is a flowchart of an example embodiment of a method 300 of providing an online emulation at a user device. Method 300 is an example of a method in which a customized software application is emulated at a user device 110 by partitioning resources into abstract categories.

At 310, a plurality of abstract resource categories can be defined. The abstract categories may be defined by the host processing unit 132 and stored in the host memory 136. The abstract resource categories may identify abstract categories of resources available for emulation via host server 130.

As explained herein above, abstract categories may be used to group one or more functionalities or resources. These abstract resource categories may also be referred to as containers or templates. Each abstract resource categories can be defined to include at least one associated resource 138. The associated resource 138 may be allocated to a particular abstract resource category based on its corresponding functionality and the set of functionalities associated with the abstract resource category.

For example, an abstract resource category may be defined for a particular type of word processing application (e.g. Microsoft Word). The set of functionalities for that abstract resource category may correspond to the plurality of functionalities provided by all the different versions of Microsoft Word available in the host server 130 (i.e. the initial software applications).

At 320, the host server 130 can partition plurality of resources 139 between the plurality of abstract resource categories. Partitioning may also be referred to as containerization or categorization. Each resource 138 may be partitioned into a corresponding abstract resource category in the plurality of abstract resource categories. The abstract resource categories may each include one or more resources 138. At least one of the abstract resource categories may include a plurality of resources 138.

In some embodiments, the host server 130 may also take into account the resources available locally at the user device 110. The host server 130 may determine a plurality of user-side resources 118 usable to provide the emulation at the user device 110. These user-side resources refer to the resources available locally on the user device 110.

The host server 130 may then partition the plurality of user-side resources 118 between the plurality of abstract resource categories. As with the resources 138, each user-side resource 118 can be partitioned into a corresponding abstract resource category. In some cases, the abstract categories may include both remote resources 138 and user-side resources 118. That is, at least one of the abstract resource categories may include at least one resource 138 and at least one user-side resources 118.

The portioning of resources into abstract resource categories may not be limited by the organization of physical files. For example, partitioning and abstract categorization can be done in a way that an abstract resource category may include subroutines from multiple files.

In some embodiments, after a particular customized software application for emulation is determined, the host server 130 can determine a set of functionality kinds for providing that emulation. Specifically, the set of functionality kinds can be determined such that during each time interval within the emulation, and for each functionality kind in the set of functionality kinds, a corresponding resource can be made available to be used by the host server 130 during that time interval to provide a corresponding functionality within that functionality kind.

In other words, the set of functionality kinds can be defined in relation to the set of functionalities for the particular customized software application. The set of functionalities can then be defined to fall within the set of functionality kinds, in that each functionality in the set of functionalities can fall within a corresponding functionality kind in the set of functionality kinds. However, more than one functionality in the set of functionalities may fall within the same functionality kind. For example, in an embodiment of the invention where the host server 130 switches from a first phase of the emulation in which a first resource is used, to a second phase of the emulation where a second resource is used, the first resource and the second resource may both fall within the same functionality kind.

Consider an example of a customized word processing application. For the most part, the word processing application may function as a legacy or relatively early version word processing application, including having a first resource, provided by an early version of that word processing application, which can be made available for editing functions. This first resource can be a specific resource in a plurality of resources required to provide the emulation, and can provide a specific functionality that can be used during the emulation. This specific functionality is a functionality in the set of functionalities. This specific functionality may also fall within a functionality kind—call this functionality kind EDITING.

In some instances, a plurality of abstract resource categories constructed to provide the emulation can include an abstract resource category corresponding to the functionality kind (here the EDITING functionality kind). This abstract resource category could include a second resource also providing an editing functionality, but one that is slightly different, in that it enables chemical equation editing for example. The set of functionalities for the customized software application may include the functionality provided by the first resource and the functionality provided by the second resource, but both of these functionalities can be subsumed within the functionality kind EDITING.

According to some embodiments, defining a set of functionality kinds based on the emulation to be provided (i.e. based on the set of functionalities for a particular customized software application) may be used to define the plurality of abstract resource categories for providing the emulation. In some embodiments, each abstract resource category may correspond to a corresponding functionality kind in the set of functionality kinds. In partitioning the plurality of resources into the plurality of abstract resource categories, a resource may be allocated to a particular abstract resource category by i) determining a functionality provided by that resource; ii) determining a corresponding functionality kind into which that functionality falls; and then iii) allocating that resource to the particular abstract resource category for that corresponding functionality kind.

In some embodiments, one or more abstract resource categories may be defined to include a plurality of functionality kinds. The resources 138 may be partitioned into such abstract resource categories such that at least one resource that provides the corresponding functionality kind is defined in each abstract resource category. In some cases, multiple resources 138 providing the same functionality kind (but perhaps different levels of functionality) may be partitioned into the same resource category.

In some embodiments, the abstract resource categories and the resources portioned thereon may be defined as a container a resources. When a user requests an emulation of a customized software application, the host server 130 may identify a corresponding abstract resource category container that includes functionality kinds corresponding to each functionality in the set of functionalities for that customized software application. Thus, some or all of the resources in that abstract resource category container can be accessed and operated to provide the emulation requested. In some instances, the abstract resource category may include additional resources falling within functionality kinds that correspond to the set of functionalities of the customized software application that are not provided to the requesting user, for instance based on user access information or because that level of functionality is not required for the customized software application. The abstract resource category containers may also include multiple resources corresponding to the same functionality kind, but providing different levels of functionality (e.g. various types of EDITING resources) that can be provided in different phases of the emulation as required.

At 330, the host server 130 can provide a first phase of the online emulation of the customized software application. In the first phase, the host server 130 may provide the online emulation using a first resource in one of the abstract categories defined at 320. The host server may use this first resource to provide a first functionality. For example, the first functionality may be to provide text editing features of an older version of a word processing program.

At 340, the host server 130 may provide a second phase of the online emulation following the first phase provided at 330. In the second phase, the host server 130 may provide the online emulation using a second resource from the same abstract category as the first resource. That is, the resource used in the second phase is different from the resource used in the first phase, but from the same abstract category. In some cases, the resource used in the second phase may be in addition to the first resource (i.e. both the first and second resource are used at the same time). In other cases, the first resource may not be used in the second phase. For instance, the second resource may be used in place of the first resources.

In some cases, the host server 130 may use the second resource to provide a second functionality that is different than the first functionality. For example, the second functionality may be features of a newer version of the word processing program, such as an equation editing feature.

Different phases of an online emulation may be used to transition between providing different functionalities (and the corresponding resources) or switching between resources for other reasons. For instance, the host server 130 may transition between phases of an emulation to switch between using a resource 138 and a user-side resource 118.

The host server 130 may provide an initial phase of the online emulation during which the host server 130 provides the online emulation using an initial resource. The host server 130 may then provide a subsequent phase of the online emulation using a subsequent resource. In some cases, the initial resource may be a resource 138 while the subsequent resource is a user-side resource 118. Alternatively, the initial resource may be a user-side resource 118 while the subsequent resource is a resource 138. Thus, the host server 130 may switch between using the local resources on device 110 and resources 138 available through the host server 130.

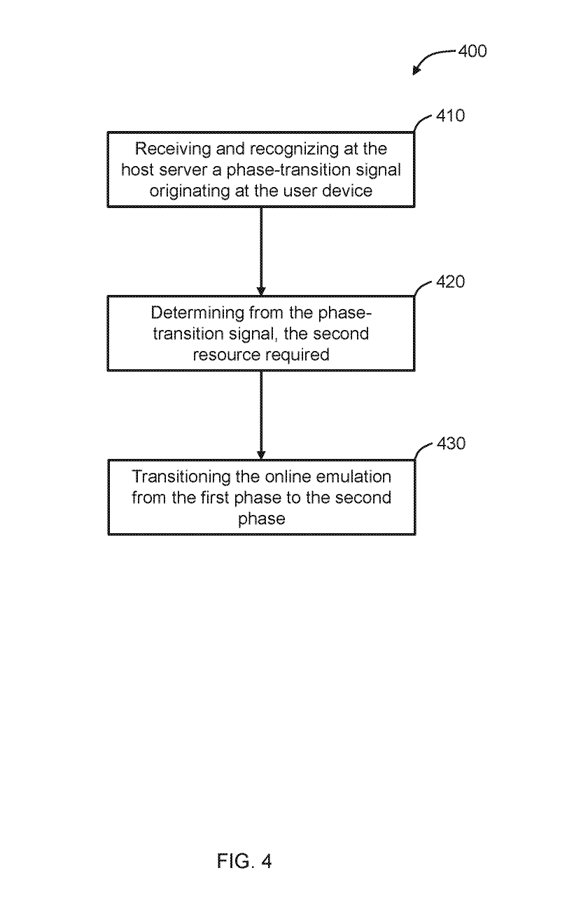

Referring now to FIG. 4, shown therein is an example embodiment of a process 400 for transitioning between phases in an online emulation. Process 400 may be used with various processes for providing online emulations, such as processes 200 and 300 described herein above. Process 400 is an example of a method for modifying the emulation of resources provided to a user device in response to changes associated with the user device 110.

At 410, the host server 130 may receive a phase-transition signal originating from the user device 110. In some cases, the phase-transition signal may be initiated based on an action by the user of user device 110, such as selecting an equation. In other cases, the phase-transition signal may be initiated based on a change in location data associated with the user device, such as the user moving from one geographic region to another.

At 420, host server 130 may recognize the phase transition signal, and determine from the signal the type of transition required. In examples where the phase transition signal is initiated by a user action, the host server 130 may determine a second functionality required based on the user action. The host server may then determine a second resource required to provide that second functionality (e.g. an equation editing resource).

For example, a user may be attempting to edit a chemical equation using a resource, partitioned from an earlier version of a word processing application, which is unsuitable to provide that functionality. Based on the user's attempt to edit the chemical equation and the unavailability of that functionality in the first resource, a phase transition signal may be sent by the mobile device to the host server 130. The functionality required to edit the chemical equation may then be identified by the host server 130 from a later version of the word processing application.

In examples where the phase transition signal is initiated by a change in location of the user device, the host server 130 may determine a second resource required based on the change in location. The host server 130 may identify the second resource as a resource geographically proximate to the new device location.

For example, a user, located in Canada, may be provided an online emulation using resources accessible through a server hosted in Canada. When the user relocates to the US, the host server 130 may determine that resources are available through a server hosted in the US to provide the online emulation. In such a case, the phase transition may result in reduced latency for the user.

At 430, the host server 130 may transition the online emulation from a first phase (in which a first resource was provided) to a second phase in which the second resource determined at 420 is provided.

The emulation server may transition between the first phase and the second phase in a variety of ways. In one embodiment, the host server receives a phase-transition signal, determines the second resource based on the phase-transition signal, and transitions the online emulation from the first phase to the second phase.

The phase transition signal may also change based on the availability of resources. For example, if additional resources became available at a location closer to the user, the host server 130 may initiate a phase transition to provide reduced latency for the user.

In some cases, a phase transition may occur as a result of other online emulations being provided by the host server 130. For instance, the host server 130 may provide an additional online emulation at a second user device 110B. The host server 130 may determine that a first resource (currently used to provide an emulation for a first user device 110A) is to be used to provide the additional online emulation. The host server 130 may then switch the online emulation (for the first user device 110A) from a first phase using the first resource to a second phase not using the first resource. The host server 130 may then use the first resource to provide the additional online emulation to the second user device 110B while the emulation for the first user device 110A operates in the second phase. For instance, the server 130 may cause this transition to provide a reduced cumulative latency for the first emulation and the second emulation (i.e. based on the geographic locations of the users 110A and 110B and resources 138).

In some cases, a phase transition may occur as a result of a problem in relation to the first resource that is being used to provide an online emulation. For instance, the data center providing the first resource may become inaccessible for whatever reason, either because the data center itself has gone down, the first resource at the data center has gone down, or communications with the data center have been interrupted. In response, the host server 130 may switch the online emulation from a first phase using a first resource to a second phase not using the first resource. For instance, the second resource may be hosted on another data center that is still accessible.

Although the above description refers to transition between two phases, a first and second resource or a first and second functionality, it will be appreciated that transitions may be between more than two phases. Similarly, it will be appreciated that transitions may involve more than two resources or functionalities.

Although the above description generally refers to emulation of one customized software application at one user device, it will be appreciated that a plurality of emulations of customized software applications may be provided at a plurality of user devices. Moreover, the customized software applications emulated at each user device may be the same or different.

The host server 130 may provide a plurality of online emulations to a plurality of user devices 110. The plurality of online emulations may be provided concurrently. Customized software applications may be defined for each of the user devices 110, and the corresponding resources provided. In some cases, the customized software application for emulation at a first user device 110A may differ from the customized software application for emulation at a second user device 110B.

Furthermore, access to certain resources within abstract categories by certain users may be denied. For example, in one embodiment, access may be denied based on the customized software application being emulated. For example, if the customized software application being emulated is a customized version of a word processing application, access to resources related to a spreadsheet application may be denied. In some cases, users may be denied access entire abstract resource categories.

Restriction to certain resources within abstract categories or entire abstract categories may be referred to as policy settings. Such policies may defined by an administrative user or a developer of a customized software application. Policies may be manually defined by the user of a user device, for example, using a graphical user interface. Policies may be defined by a default set of policies. The default set of policies may be based on historical use of emulation services, for example, using machine learning algorithms.

In another example, a plurality of user records may be maintained. The user records may be stored at the host storage 138. The plurality of user records may include a user record identifying each user, with corresponding user access information. Access to certain resources within abstract categories may be restricted based on the user access information. Access may also be restricted based on both the user access information and the customized software application being emulated. Access may be prioritized based on the access information. For example, a first user may be associated with access information indicating that a higher priority than a second user. When both the first user and second user attempt to access a resource, priority can be given the first user.

While the above description describes features of example embodiments, it will be appreciated that some features and/or functions of the described embodiments are susceptible to modification without departing from the spirit and principles of operation of the described embodiments. For example, the various characteristics which are described by means of the represented embodiments or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A method of providing, at a user device, an online emulation via a host server, the method comprising:
providing a plurality of resources via the host server by providing a plurality of initial software applications, wherein each initial software application in the plurality of software applications comprises at least one associated resource in the plurality of resources, and each resource in the plurality of resources is included in at least one initial software application in the plurality of initial software applications;
defining a customized software application for emulation at the user device via the host server, wherein emulation of the customized software application involves a set of functionalities, and, relative to each initial software application in the plurality of initial software applications, the set of functionalities comprises a distinguishing functionality of the customized software application absent from that initial software application;
operating the host server to determine a set of resources in the plurality of resources for providing the customized software application by, for each functionality in the set of functionalities, determining a corresponding resource in the plurality of resources for providing that functionality; and
providing the online emulation via the host server of the customized software application by accessing and running the set of resources.

2. The method as defined in claim 1 further comprising
defining a plurality of abstract resource categories accessible via the host server, wherein each abstract resource category in the plurality of abstract resource categories comprises at least one associated resource in the plurality of resources for providing at least one functionality in the set of functionalities;
partitioning the plurality of resources between the plurality of abstract resource categories such that each resource in the plurality of resources is partitioned into a corresponding abstract resource category in the plurality of abstract resource categories, and at least one abstract resource category in the plurality of abstract resource categories comprises at least two resources in the plurality of resources; and,
providing the online emulation via the host server of the customized software application comprises providing at least a first phase of the online emulation via the host server of the customized software application followed by providing a second phase of the online emulation via the host server of the customized software application, wherein during the first phase of the online emulation, the host server provides the online emulation using a first resource of the at least two resources in the plurality of resources and during the second phase of the online emulation, the host server provides the online emulation using a second resource of the at least two resources in the plurality of resources.

3. The method as defined in claim 2 wherein during the first phase of the online emulation, the host server provides the online emulation using the first resource of the at least two resources in the plurality of resources to provide a first functionality in the set of functionalities, and during the second phase of the online emulation, the host server provides the online emulation using a second resource of the at least two resources in the plurality of resources to provide a second functionality in the set of functionalities, the first functionality being different from the second functionality

4. The method as defined in claim 3, further comprising
receiving and recognizing at the host server a phase-transition signal originating at the user device based on an action by the user;
determining from the phase-transition signal, the second functionality in the at least two functionalities in the set of functionalities required based on the user action, and the second resource in the at least two resources in the plurality of resources required to provide that second functionality; and,
responsive to determining from the phase-transition signal, the second functionality and the second resource, transitioning the online emulation from the first phase to the second phase.

5. The method as defined in claim 2 further comprising:
receiving and recognizing at the host server a phase-transition signal originating at the user device based on a change in location of the user device;
determining from the phase-transition signal, the second resource of the at least two resources required based on the change in location of the user device; and,
responsive to determining from the phase-transition signal the second resource, transitioning the online emulation from the first phase to the second phase.

6. The method as defined in claim 2 further comprising providing an additional online emulation at another user device via the host server;
during the additional online emulation, determining that the first resource of the at least two resources in the plurality of resources is to be used to provide the additional online emulation; and,
switching the online emulation from the first phase using the first resource of the at least two resources to the second phase not using the first resource of the at least two resources, and then, during the second phase, using the first resource of the at least two resources to provide the additional online emulation to the another user device.

7. The method as defined in claim 2 further comprising
determining a problem in relation to the first resource of the at least two resources; and
in response to determining the problem in relation to the first resource of the at least two resources, switching the online emulation from the first phase using the first resource of the at least two resources to the second phase not using the first resource of the at least two resources.

8. The method as defined in claim 2 further comprising
determining a plurality of user-side resources usable to provide the emulation at the user device, the user-side resources being available on the user device;
partitioning the plurality of user-side resources between the plurality of abstract resource categories such that each user-side resource in the plurality of user-side resources is partitioned into a corresponding abstract resource category in the plurality of abstract resource categories, and at least one other abstract resource category in the plurality of abstract resource categories comprises at least one resource in the plurality of resources and at least one user-side resource in the plurality of user-side resources;
providing the online emulation via the host server of the customized software application comprises providing an initial phase of the online emulation via the host server of the customized software application followed by providing a subsequent phase of the online emulation via the host server of the customized software application,
wherein
during the initial phase of the online emulation, the host server provides the online emulation using an initial resource in the at least one other abstract resource category;
during the subsequent phase of the online emulation, the host server provides the online emulation using a subsequent resource in the other abstract resource category; and
the plurality of resources comprises one of the initial resource and the subsequent resource, and the plurality of user-side resources comprises the other of the initial resource in a subsequent resource.

9. The method as defined in claim 1 wherein
providing, at the user device, the online emulation via the host server comprises providing, at a plurality of user devices, a plurality of online emulations via the host server; and
defining the customized software application for emulation at the user device comprises, for each user device in the plurality of user devices, defining a corresponding customized software application for emulation at that user device.

10. The method as defined in claim 9 wherein for at least a first user device in the plurality of user devices, and a second user device in the plurality of user devices, the customized software application for emulation at the first user device differs from the customized software application for emulation at the second user device.

11. The method as defined in claim 10 further comprising for at least some user devices in the plurality of user devices, denying access to resources within at least one abstract resource category in the plurality of abstract resource categories based, at least in part, on the corresponding customized software application being emulated at that user device.

12. The method as defined in claim 10 further comprising
providing a plurality of user records defining a plurality of users, wherein i) for each user device in the plurality of user devices, the plurality of user records comprises a user record identifying a corresponding user for that user device; and, ii) each user record in the plurality of user records comprises a corresponding user access information; and,
for at least some user devices in the plurality of user devices, denying access to resources within at least one abstract resource category in the plurality of abstract resource categories based, at least in part, on the corresponding user access information stored in the user record for that user device.

13. The method as defined in claim 10 further comprising
providing a plurality of user records defining a plurality of users, wherein i) for each user device in the plurality of user devices, the plurality of user records comprises a user record identifying a corresponding user for that user device; and, ii) each user record in the plurality of user records comprises a corresponding user access information; and,
for at least some user devices in the plurality of user devices, denying access to resources within at least one abstract resource category in the plurality of abstract resource categories based, at least in part, on the corresponding user access information stored in the user record for that user device and the corresponding customized software application being emulated at that user device.

14. A system for providing an online emulation at a user device, the system comprising:
a host server in communication with the user device, the host server comprising a host processor and a host memory;
wherein
the host memory is configured to store a plurality of initial software applications accessible via the host server, each initial software application in the plurality of software applications comprising at least one associated resource in a plurality of resources, and each resource in the plurality of resources is included in at least one initial software application in the plurality of initial software applications; and
the host processor is configured to:
define a customized software application for emulation at the user device, wherein emulation of the customized software application involves a set of functionalities, and, relative to each initial software application in the plurality of initial software applications stored in the host memory, the set of functionalities comprises a distinguishing functionality of the customized software application absent from that initial software application;
determine a set of resources in the plurality of resources for providing the customized software application by, for each functionality in the set of functionalities, determining a corresponding resource in the plurality of resources for providing that functionality; and
provide the online emulation of the customized software application by accessing and running the set of resources.

15. The system of claim 14, wherein the host processor is further configured to:
define a plurality of abstract resource categories accessible via the host server, wherein each abstract resource category in the plurality of abstract resource categories comprises at least one associated resource in the plurality of resources for providing at least one functionality in the set of functionalities;
store the plurality of abstract resource categories in the host memory;
partition the plurality of resources between the plurality of abstract resource categories such that each resource in the plurality of resources is partitioned into a corresponding abstract resource category in the plurality of abstract resource categories, and at least one abstract resource category in the plurality of abstract resource categories comprises at least two resources in the plurality of resources; and,
provide the online emulation of the customized software application by providing at least a first phase of the online emulation of the customized software application followed by providing a second phase of the online emulation of the customized software application, wherein during the first phase of the online emulation, the online emulation is provided using a first resource of the at least two resources in the plurality of resources and during the second phase of the online emulation the online emulation is provided using a second resource of the at least two resources in the plurality of resources.

16. The system as defined in claim 15 wherein the host processor is further configured to:
provide the online emulation using the first resource of the at least two resources in the plurality of resources to provide a first functionality in the set of functionalities during the first phase of the online emulation; and
provide the online emulation using a second resource of the at least two resources in the plurality of resources to provide a second functionality in the set of functionalities during the second phase of the online emulation, wherein the first functionality is different from the second functionality.

17. The system as defined in claim 16, wherein the host processor is further configured to:
receive and recognize a phase-transition signal originating at the user device based on an action by the user;
determine from the phase-transition signal, the second functionality in the at least two functionalities in the set of functionalities required based on the user action, and the second resource in the at least two resources in the plurality of resources required to provide that second functionality; and,
transition the online emulation from the first phase to the second phase in response to determining the second functionality and the second resource from the phase-transition signal.

18. The system as defined in claim 15, wherein the host processor is further configured to:
receive and recognize a phase-transition signal originating at the user device based on a change in location of the user device;
determine from the phase-transition signal, the second resource of the at least two resources required based on the change in location of the user device; and,
transition the online emulation from the first phase to the second phase in response to determining the second resource from the phase-transition signal.

19. The system as defined in claim 15 wherein the host processor is further configured to:
provide an additional online emulation at another user device;
determine that the first resource of the at least two resources in the plurality of resources is to be used to provide the additional online emulation;
switch the online emulation from the first phase using the first resource of the at least two resources to the second phase not using the first resource of the at least two resources; and
subsequently, during the second phase, use the first resource of the at least two resources to provide the additional online emulation to the another user device.

20. The system as defined in claim 15 wherein the host processor is further configured to:
determine a problem in relation to the first resource of the at least two resources; and
switch the online emulation from the first phase using the first resource of the at least two resources to the second phase not using the first resource of the at least two resources in response to determining the problem in relation to the first resource of the at least two resources.
